(19) United States
(12) Patent Application Publication
(10) Pub. No.: US 2005/0222876 A1
(43) Pub. Date: Oct. 6, 2005

(54) System and method for disclosing personal information or medical record information and computer program product

(75) Inventors: Noboru Iwayama, Kawasaki (JP); Hiroyasu Sugano, Kawasaki (JP); Youji Kohda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/924,849

(22) Filed: Aug. 25, 2004

(30) Foreign Application Priority Data
Mar. 31, 2004 (JP) 2004-107951

(51) Int. Cl. G06F 17/60

(52) U.S. Cl. 705/3; 705/51

(57) ABSTRACT

A medical record information disclosure system includes a medical record information server for storing medical record information of patients, a policy information setting portion for setting policy information indicating an attribution of a medical expert who can see contents of medical record information for each medical record information, an authority system for setting authority information for certifying an attribution of a medical expert for each of the medical experts, a disclosure permissibility decision portion for deciding whether it is permissible or not to disclose contents of the medical record information to the medical expert by comparing the authority information of the medical expert with the policy information set in the medical record information, and a medical record information output portion for delivering the medical record information to the medical expert when it is decided the disclosure of contents of the medical record information to the medical expert is permissible.

### BACKGROUND OF THE INVENTION

1. Field of the Invention

The present invention relates to a system and a method for disclosing personal information such as medical record information.

2. Description of the Prior Art

Recently, an electronic medical record system has been proposed and commercialized gradually, in which medical records of patients are stored and managed as electronic data. Use of this system facilitates disclosure of medical records from one medical institution to another medical institution via a network. If medical records of patients can be shared among plural medical institutions, more effective and efficient medical service can be provided to patients.

However, if the conventional electronic medical record system is simply connected to a network for sharing medical records, there is possibility that unspecified number of people see the medical records. Therefore, there is a system proposed as disclosed in “EMI net, Medical information network in Matsudo city”, Katsuhiko Takabayashi, New Medical Care (Shin-iryou) September, 2002, ME Promotion Association.

The system described in the above mentioned document enables a plurality of medical institutions located in a predetermined area to share medical information of patients. In order to see the information, it is necessary to obtain a user authentication by using a fingerprint or an IC card. The user authentication by using a fingerprint or an IC card is known well as described in Japanese unexamined patent publication 2002-259562.

Generally, Before a medical record is disclosed to another doctor, a doctor who wrote the medical record usually consults with the patient about the medical record to be disclosed or not. In addition, a doctor does not always disclose a medical record written by himself or herself to any doctor who is qualified for medical practice, but in most cases, he or she discloses a medical record only to a reliable doctor.

Therefore, even if the system described in the first above-mentioned document is used, promotion of sharing medical records depends on a medical institution or a connection between doctors. Namely, unless a doctor has a positive thinking about disclosing medical records to other doctors, an installation of the system cannot produce an expected result.

On the other hand, patients have been increasing recently who want to know about validity of a diagnosis or a treatment plan made by a medical attendant or a family doctor. For this reason, such a patient may ask a doctor of a medical institution that has no relationship with the family doctor, i.e., a second doctor for an opinion (a second opinion). When the second doctor forms a second opinion, it is desirable for him or her to see a medical record written by the family doctor. As described above, however, the family doctor may not disclose the medical record to another doctor who does not have a connection with him or her in most cases.

According to the conventional method as described above, medical records are shared only between doctors who have a connection with each other. Therefore, when a patient asks for a second opinion, it is difficult for a second doctor to see a medical record written by a family doctor.

In addition, when setting for sharing information is performed in the method described in the first above-mentioned document, information of a patient is disclosed to every medical institution equally. Therefore, though an IC card or the like may be used for user authentication to maintain a predetermined level of security, it is inevitable that the information of the patient will be disclosed to a person who does not need the information. As a result, there is still a risk for a patient that his or her personal information might leak.

### SUMMARY OF THE INVENTION

An object of the present invention is to provide a system for disclosing personal information such as a medical record more appropriately than the conventional system.

According to one aspect of the present invention, a system for disclosing personal information includes a storage portion for storing personal information of people who are provided with a service, a disclosure attribution setting portion for setting a disclosure attribution for each of the personal information, the disclosure attribution being an attribution of people who can see contents of the personal information, a provider attribution setting portion for setting a provider attribution for each of service providers, the provider attribution being an attribution about a service provider, a disclosure permissibility decision portion for deciding whether it is permissible or not to disclose the personal information to the provider by comparing the provider attribution of the provider with the disclosure attribution of the personal information, and an output portion for delivering the personal information to the provider when the disclosure permissibility decision portion decides it is permissible to disclose the personal information to the provider.

The system for disclosing personal information is used for disclosing a medical record, for example. The storage portion stores the personal information such as medical record information of patients who are provided with medical practice such as a medical examination. The provider attribution setting portion sets the provider attribution that is an attribution of a medical expert such as a doctor or a pharmacist. The attribution of a medical expert indicates what kind of qualification and what kind of specialty the medical expert has, for example.

The provider attribution setting portion can be plural. In this case, the disclosure permissibility decision portion decides whether it is permissible or not to disclose contents of the medical record information to the medical expert by comparing one or more of the medical expert attributions of the medical expert with the disclosure attribution of the medical record information.

According to the present invention, personal information such as a medical record can be disclosed more appropriately than the conventional system. In addition, an attribution of a medical expert such as a doctor can be set in more detail, so that a medical record can be disclosed more appropriately.

### BRIEF DESCRIPTION OF THE DRAWINGS

FIG. 1 shows an example of a general structure of a system for disclosing medical record information.

FIG. 2 shows an example of a medical record master.

FIG. 3 shows an example of an item information database.

FIG. 4 shows an example of a policy master.

FIG. 5 shows a list of examples of organizations that issue authority information.

FIG. 6 shows an example of a functional structure of a diagnostic type terminal device and a diagnostic type terminal device.

FIG. 7 shows an example of authority information that is recorded on a qualified person card.

FIG. 8 is a flowchart for explaining an example of a process for registering or updating medical record information and policy information.

FIG. 9 shows an example of a medical record screen.

FIG. 10 shows an example of a medical record edit screen.

FIG. 11 shows an example of a disclosure condition set screen.

FIG. 12 is a flowchart for explaining an example of a process for viewing medical record information.

FIG. 13 shows an example of authority information that is recorded on the qualified person card.

FIG. 14 shows an example of a medical record reference screen.

### DESCRIPTION OF THE PREFERRED EMBODIMENTS

Hereinafter, the present invention will be explained more in detail with reference to embodiments and drawings.

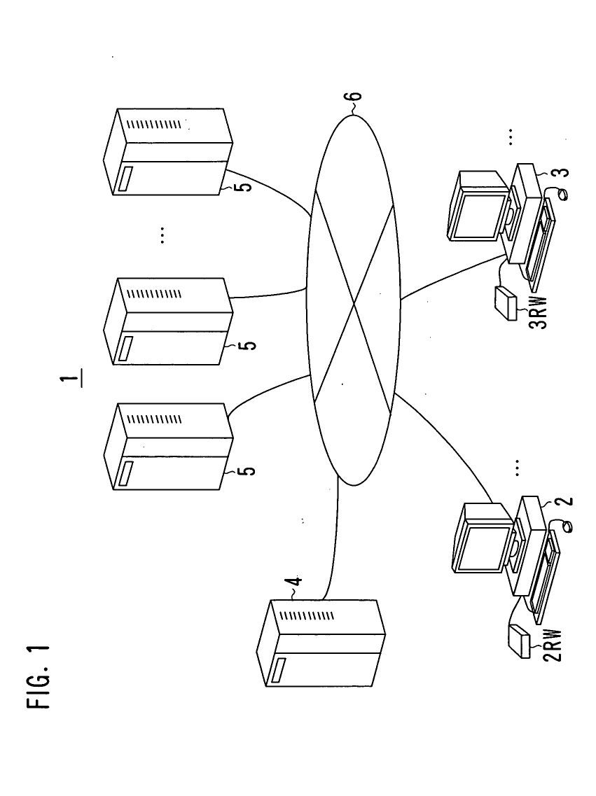

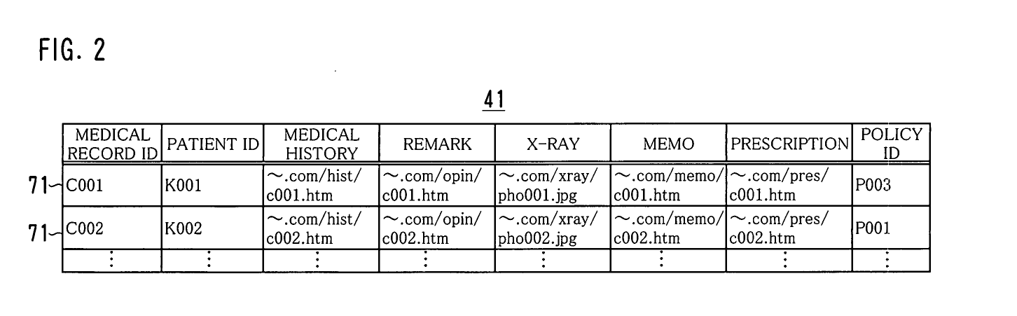

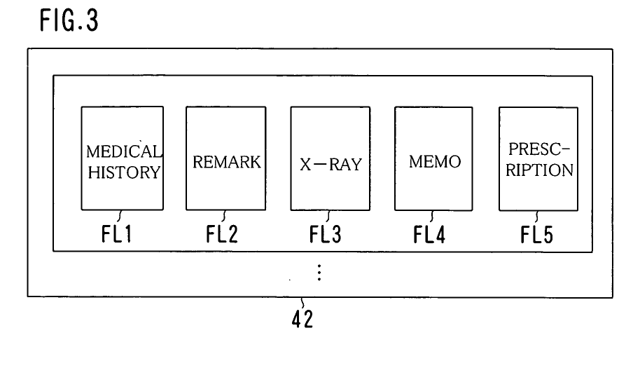

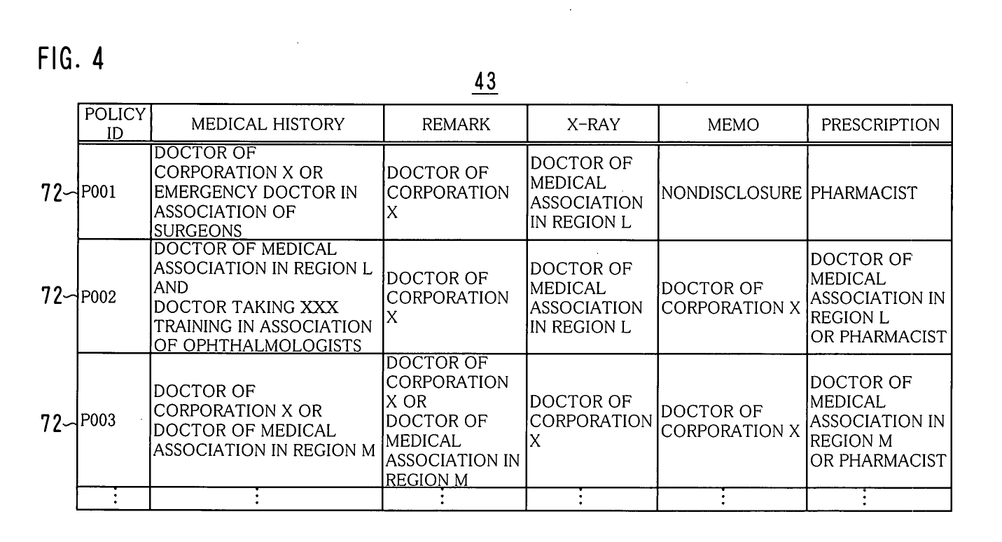

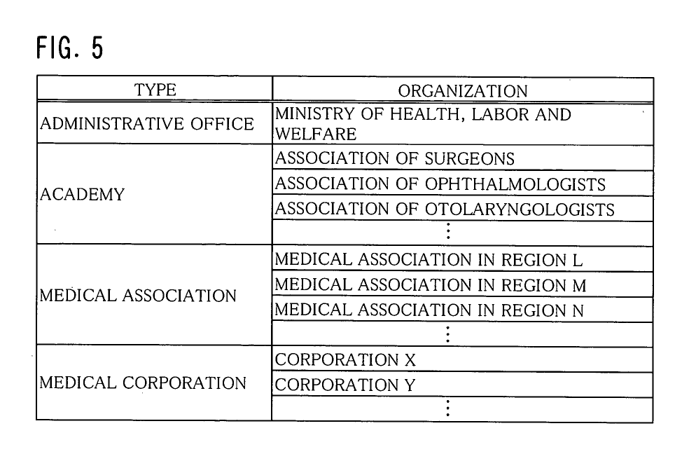

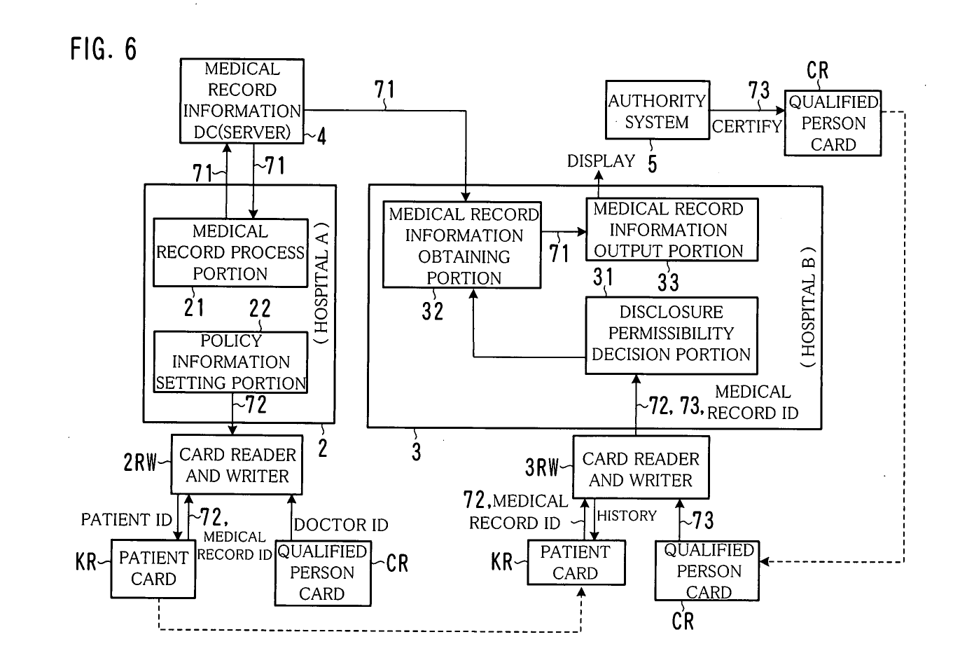

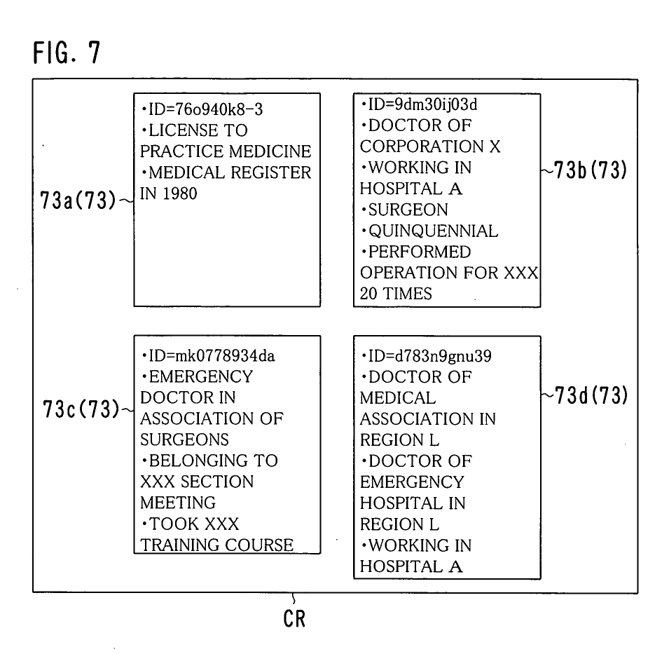

FIG. 1 shows an example of a general structure of a medical record information disclosure system 1, FIG. 2 shows an example of a medical record master 41, FIG. 3 shows an example of an item information database 42, FIG. 4 shows an example of a policy master 43, FIG. 5 shows a list of examples of organizations that issue authority information 73, FIG. 6 shows an example of a functional structure of a diagnostic type terminal device 2 and a diagnostic type terminal device 3, FIG. 7 shows an example of authority information 73 that is recorded on a qualified person card CR.

The medical record information disclosure system 1 according to the present invention includes diagnostic type terminal devices 2 and 3, a medical record information server 4, an authority system 5 and a communication line 6 as shown in FIG. 1. The diagnostic type terminal devices 2 and 3 can be connected to the medical record information server 4 and the authority system 5 via the communication line 6. As the communication line 6, the Internet, a LAN, a public circuit or a private circuit can be used.

The medical record information disclosure system 1 is used for disclosing information (i.e., a medical record) of a patient who was provided with a medical practice such as consulting, healing, an examination or a medication in a medical institution to another medical expert (e.g., a doctor, a dentist or a pharmacist) of another medical institution. Hereinafter, a case is exemplified where medical record information of a patient in a hospital A that includes a plurality of medical departments is disclosed to another medical expert in another medical institution.

The medical record information server 4 is installed in a data center for managing information about patients, doctors, dentists, pharmacists and staffs in the hospital A. The medical record information server 4 includes a medical record master 41, an item information database 42 and a policy master 43.

The medical record master 41 stores medical record information 71 of patients as shown in FIG. 2. A field “medical record ID” is identification information for identifying the medical record information 71. A field “patient ID” is identification information for identifying which patient the medical record information 71 belongs to.

Information about contents of the medical record is stored in fields “medical history”, “remark”, “X-ray”, “memo” and “prescription”. It is possible to store data of each of contents directly in these fields, but in this embodiment, URLs (Uniform Resource Locators) that indicate storage locations and names of the data are stored in these fields.

A term “policy” means a condition for disclosing the medical record information 71 to a medical expert in a medical institution except for the hospital A (hereinafter referred to as a “disclosure condition”). In this embodiment a plurality of patterns of data indicating the disclosure condition is prepared as being described later, and an ID of a pattern that is suitable for the disclosure condition (the policy ID shown in FIG. 4) is designated (stored) in the “policy ID”. It is possible to store data indicating the disclosure condition directly in the field.

The medical record information 71 also includes information about a creation date, a doctor who created it, a last update date and a last update doctor.

The item information database 42 includes five types of data as files as shown in FIG. 3. A medical history file FL1 includes information about a medical history of a patient up to now. A remark file FL2 includes information about a decision or a remark like “body temperature 38.5° C.” or “bad cough” after a certain medical practice such as consulting. An X-ray file FL3 is an image file of an X-ray photograph obtained by radiography (roentgenography). A memo file FL4 includes a memo such as “have told to come three days later if the symptom will not disappear”. A prescription file FL5 includes information about medicines that have been prescribed up to now.

Namely, the fields from “medical history” to “prescription” of the medical record information 71 shown in FIG. 2 respectively includes contents of medical record information 71 that are URLs of the medical history file FL1, . . . , the prescription file FL5. Note that it is possible that one field includes a plurality of URLs. For example, if there is a plurality of X-ray photographs, URLs of X-ray files FL3 of these X-ray photographs are stored in the field “X-ray photograph”.

The policy master 43 stores a plurality of policy information 72 that indicates a disclosure condition as shown in FIG. 4. The “policy ID” is identification information for identifying the policy information 72. The fields from “medical history” to “prescription” respectively include conditions of attributions of doctors whom contents of the item can be disclosed to. In this embodiment, cases will be described in which permissible conditions for disclosing these five items are set, but it is possible to set other items about medical practice (e.g., a remedy or a result of blood examination).

In addition, the medical record information server 4 includes a patient master storing information such as name, address, age and sex of each patient in connection with the patient ID, a doctor master for storing information such as name, department, address, age and sex of each doctor in the hospital A in connection with the doctor ID, a staff master storing information of other staff, and other databases.

With reference to FIG. 1 again, the authority system 5 is installed in an academy, a medical association, a medical corporation or a medical institution for performing a process of certifying an attribution of a medical expert who belongs to any of them. For example, it certificates an attribution that the medical expert is a doctor (a certified doctor) certified by an academy or the like, attributions of a medical department and experience of the medical expert, or about training courses the medical expert has taken.

In this embodiment an example will be described in which the authority system 5 is installed in an academy of each department such as surgery or ophthalmology, in a medical association of each region and in each organization such as a medical corporation running one or more medical institutions as shown in FIG. 5. It is supposed that the hospital A is one of hospitals that the medical corporation X is running and is located in the region L. In addition, the authority system 5 is also installed in a government institution that qualifies as medical experts including a doctor, a dentist and a pharmacist (Ministry of Health, Labor and Welfare in Japan) so as to perform a process for certifying validity of a qualification (a doctor, a dentist, a pharmacist or the like) that the medical expert has. In this way, the authority system 5 is an official or a reliable authentication basis.

The diagnostic type terminal device 2 is installed at least one for each department in the hospital A. Programs and data are installed in the diagnostic type terminal device 2 so as to realize functions including a medical record process portion 21 and a policy information setting portion 22 as shown in FIG. 6. In addition, the diagnostic type terminal device 2 is connected to a card reader and writer 2RW for reading and writing information in an IC card.

The diagnostic type terminal device 3 is installed in a medical institution except for the hospital A. Programs and data are installed in the diagnostic type terminal device 3 so as to realize functions including a disclosure permissibility decision portion 31, a medical record information obtaining portion 32 and a medical record information output portion 33 as shown in FIG. 6. In addition, the diagnostic type terminal device 3 is also connected to a card reader and writer 3RW.

Each of the medical experts in the hospital A is provided with a qualified person card CR in which an IC chip is embedded. In addition, medical experts of other hospitals are also provided with qualified person cards CR. The qualified person card CR stores information about attributions of the medical expert. The information is recorded in the qualified person card CR by the authority system 5. On this occasion, each organization examines identity of the medical expert such as a qualification the medical expert has, a predetermined training course the medical expert took or the membership of the organization the medical expert has. Namely, the information is for certifying that the attribution of the medical expert is authentic and that the medical expert is a doctor certified by the organization. Hereinafter, the information is referred to as “authority information 73”.

For example, the qualified person card CR of a doctor DR1 who is a surgeon in the hospital A stores authority information 73 including authority information 73a certified by Ministry of Health, Labor and Welfare, authority information 73b certified by the medical corporation X, authority information 73c certified by Association of surgeons and authority information 73d certified by the medical association in the region L as shown in FIG. 7. Furthermore, the qualified person card CR stores a doctor ID, a name, a default policy ID and others that are necessary when the doctor DR1 uses the diagnostic type terminal device 2.

Patients in the hospital A are provided with patient cards KR. This patient card KR stores an ID for identifying the card, a name of the patient, policy information 72 that is a disclosure condition for the medical record information 71 of the patient and other information.

Hereinafter, contents of processes of each device of the medical record information disclosure system 1 will be described by dividing the processes into processes for registering the medical record information 71 and the policy information 72, and processes for viewing the medical record information 71.

(Processes for Registering the Medical Record Information 71 and the Policy Information 72)

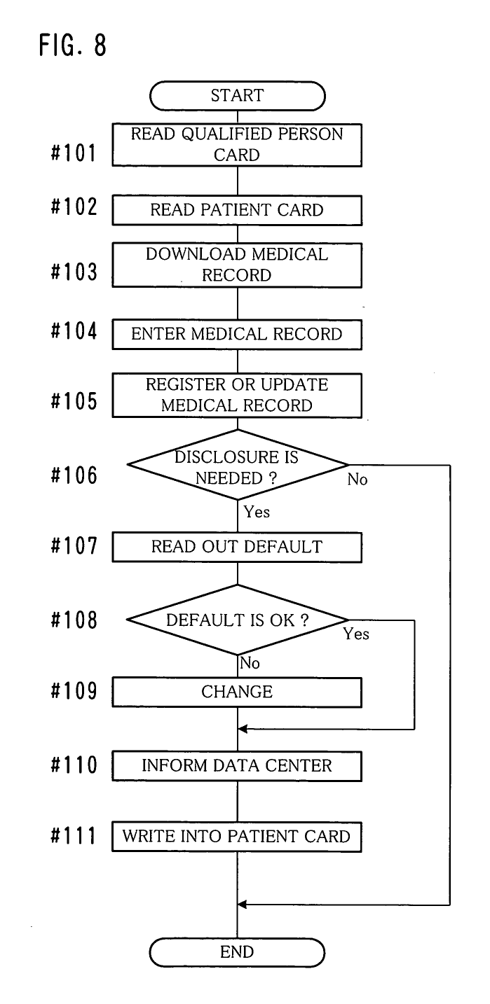

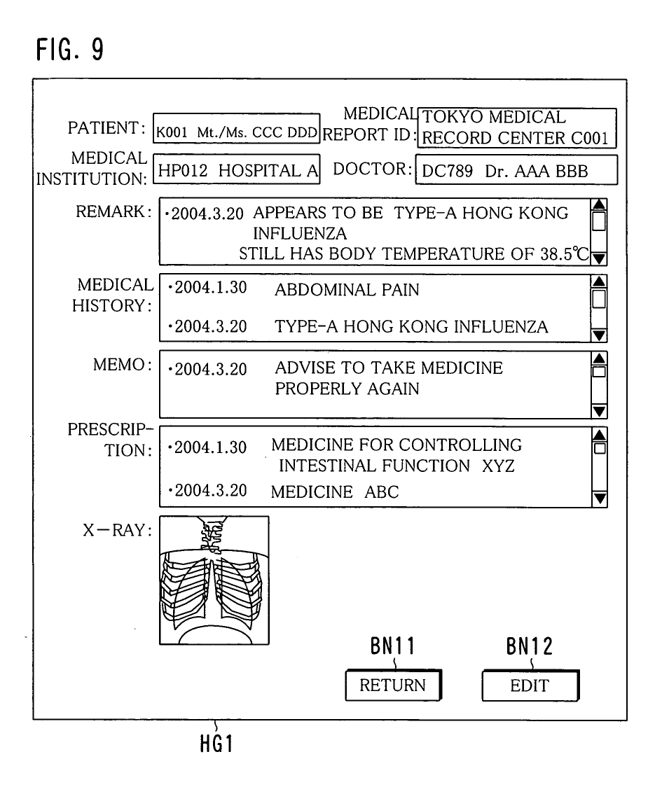

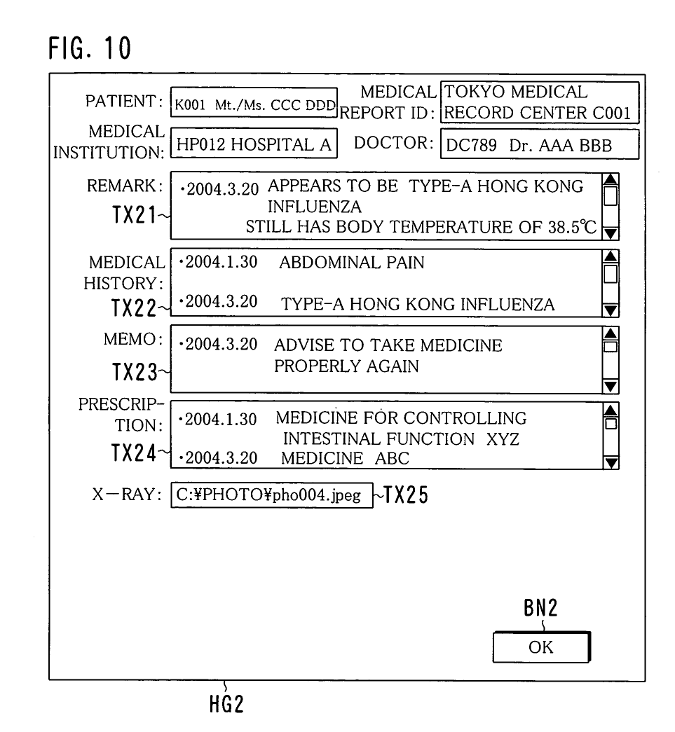

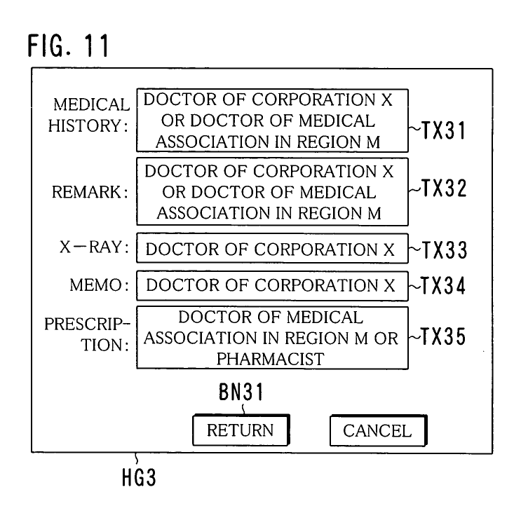

FIG. 8 is a flowchart for explaining an example of a process for registering or updating medical record information 71 and policy information 72, FIG. 9 shows an example of a medical record screen HG1, FIG. 10 shows an example of a medical record edit screen HG2, and FIG. 11 shows an example of a disclosure condition set screen HG3.

In FIG. 6, the medical record process portion 21 of the diagnostic type terminal device 2 performs a process for registering the medical record information 71 in the medical record master 41 of the medical record information server 4 or updating the existing medical record information 71. The policy information setting portion 22 performs a process for setting a disclosure condition of the medical record information 71, i.e., the policy information 72. These processes are performed in a procedure as shown in FIG. 8. Hereinafter, a case will be described in which the doctor DR1 in the hospital A performs consulting of a patient KN1.

Before starting the consulting, the doctor DR1 sets his or her qualified person card CR (see FIG. 7) to the card reader and writer 2RW. The card reader and writer 2RW reads the doctor ID, the name, the default policy ID and other information that are recorded in the qualified person card CR (#101). Then, the patient card KR of the patient KN1 who is to be consulted is set to the card reader and writer 2RW. The card reader and writer 2RW reads the ID of the patient KN1 (#102). Note that the process for reading the qualified person card CR in the step #101 may be performed every time when consulting or only once when the clinic starts on the day.

Then, the medical record process portion 21 downloads the medical record information 71 (see FIG. 2) corresponding to the ID of the patient KN1 from the medical record information server 4 (#103). On this occasion, the medical history file FL1, . . . , the prescription file FL5 corresponding to URLs of “medical history”, . . . , “prescription” are also downloaded. The downloaded medical record information 71 and contents of each file are displayed as the medical record screen HG1 on the display device of the diagnostic type terminal device 2 as shown in FIG. 9.

The doctor DR1 clicks an edit button BN12 in order to edit the medical record information 71. Then, the medical record edit screen HG2 as shown in FIG. 10 is displayed. The doctor DR1 performs editing work of the medical record while viewing the medical record edit screen HG2. Note that if it is the first time for the patient KN1, there is no medical record information 71, so the medical record edit screen HG2 is displayed promptly when the patient card KR is read in the step #102.

The doctor DR1 enters a result of consultation with the patient KN1 and others in text boxes TX21-TX25 (#104). However, a URL of an image file of an X-ray photograph (the X-ray file FL3) is entered in the text box TX25, or an image is pasted there. After the input process is finished and an OK button BN2 is clicked, the entered contents are displayed as a medical record screen HG1, so the doctor DR1 confirms there is no mistake and clicks the return button BN11.

Then, the medical record process portion 21 transmits the contents that were entered into the text boxes TX21-TX25 to the medical record information server 4. The medical record information server 4 performs a process for updating or registering the medical record information 71 and the medical history file FL1, . . . , the prescription file FL5 in accordance with the received contents (#105). In this way, registration or update of the medical record of the patient KN1 is completed.

The patient KN1 can have his or her medical record information 71 disclosed to a doctor or other medical expert of a medical institution except for the hospital A so as to take a healing or a second opinion also in the medical institution except for the hospital A. In this case (Yes in #106), the doctor DR1 performs a predetermined operation so that the disclosure condition set screen HG3 as shown in FIG. 11 is displayed on the display device of the diagnostic type terminal device 2. Disclosure condition of the contents about the medical history, the remark, the X-ray, the memo and the prescription of the medical record information 71 of the patient KN1 are respectively entered in the text boxes TX31-TX35.

Default data entered in these text boxes are the policy information 72 (see FIG. 4) corresponding to the policy ID read in the step #101 and read out by the policy master 43 (#107). Note that the disclosure condition is not limited to setting of this item, but it is possible to set only for one of data of the medical history.

The doctor DR1 consults with the patient KN1 to decide the disclosure condition of the medical record information 71. If the default policy information 72 of the doctor DR1 is acceptable (Yes in #108), the return button BN31 is clicked. Then, the policy information setting portion 22 transmits the policy ID read in the step #101 to the medical record information server 4 (#110) and writes the medical record ID of the medical record information 71 and the policy information 72 of the policy ID being connected to each other into the patient card KR of the patient KN1 (#111). The medical record information server 4 receives the policy ID and stores the same in “policy ID” of the medical record information 71.

If other policy information is desired than the default policy information 72 (the disclosure condition) (No in #108), the doctor DR1 changes contents in the text boxes TX31-TX35 (#109) and clicks the return button BN31. Then, the policy information setting portion 22 transmits the contents to the medical record information server 4 (#110) and writes the same being connected with the medical record ID of the medical record information 71 into the patient card KR of the patient KN1 (#111). The medical record information server 4 receives the contents as new policy information 72 and registers the same in the policy master 43. The medical record information server 4 also stores the policy ID of the new policy information 72 in “policy ID” of the medical record information 71 of the patient KN1.

(Process for Viewing the Medical Record Information 71)

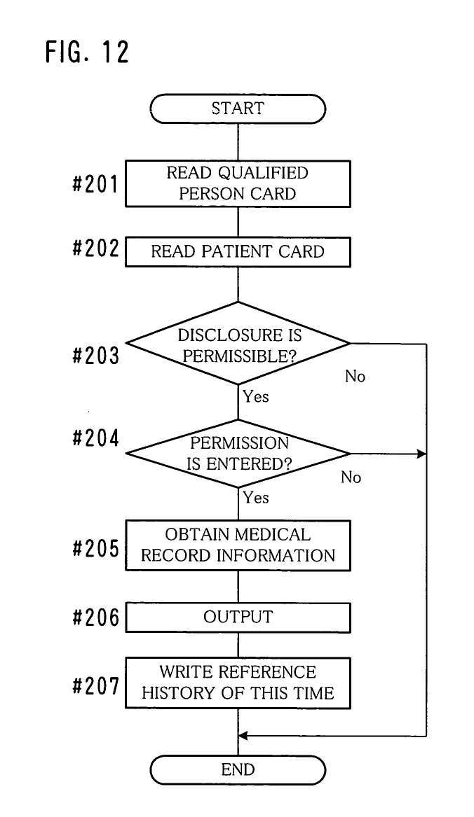

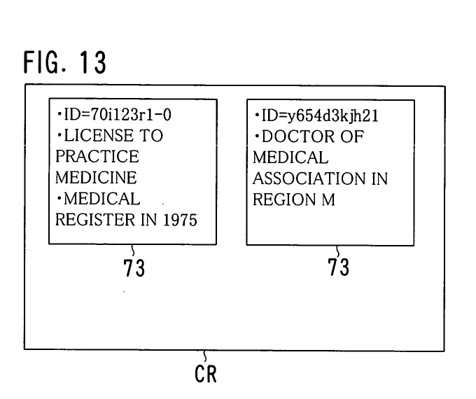

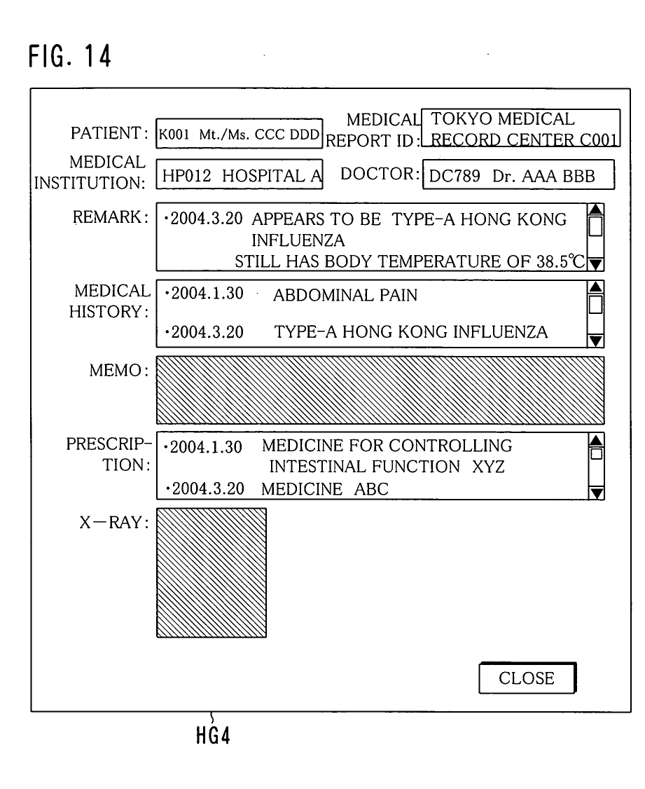

FIG. 12 is a flowchart for explaining an example of a process for viewing medical record information 71, FIG. 13 shows an example of authority information 73 that is recorded on the qualified person card CR, and FIG. 14 shows an example of a medical record reference screen HG4.

The diagnostic type terminal device 3 obtains the medical record information 71 of the patient in the hospital A who visits for consulting in a procedure as shown in FIG. 12, so as to deliver the same to a doctor or other medical expert. Hereinafter, a case will be described in which the patient KN1 takes consulting with a doctor DR2 in a hospital B that is located in the region M.

The qualified person card CR of the doctor DR2 stores the authority information 73 as shown in FIG. 13. It is supposed that the patient KN1 often visits the region M, and the patient card KR of the patient KN1 is preliminarily set so that the medical record information 71 made by the doctor in a hospital A can be disclosed to a doctor in the region M. For example, it is supposed that the policy information 72 having the same contents as “policy ID=P003” as shown in FIG. 4 is recorded in the patient card KR.

In FIG. 6, the doctor DR2 sets his or her qualified person card CR to the card reader and writer 2RW so that the card reader and writer 2RW reads the policy information 72 recorded in the qualified person card CR (#201 in FIG. 12). The patient card KR of the patient KN1 is set to the card reader and writer 2RW, so that the policy information 72 and the medical record ID recorded in the patient card KR are read out (#202). Note that the process for reading the qualified person card CR in the step #201 may be performed every time when consulting or only once when the clinic starts on the day.

The disclosure permissibility decision portion 31 compares the read policy information 72 with the authority information 73 so as to decide whether it is permissible to disclose the medical record information 71 of the read medical record ID (#203). For example, the policy information 72 and the authority information 73 are expressed by binary numbers, and a logical product (AND) of them is operated. If the result is “1”, it can be decided that the disclosure is permissible.

As shown in “policy ID=P003” shown in FIG. 4, the policy information 72 includes an attribution of “a doctor of the medical association in the region M” as the disclosure condition of “medical history”, “remark” and “prescription”, but the disclosure condition of “X-ray” and “memo” only includes an attribution of “a doctor of the corporation X”. In addition, as shown in FIG. 13, the qualified person card CR of the doctor DR2 stores the authority information 73 that certifies “a doctor of the medical association in the region M” but does not store the authority information 73 that certifies “a doctor of the corporation X”. Therefore, the obtained decision result indicates it is permissible to disclose only contents of “medical history”, “remark” and “prescription” of the medical record information 71 of the patient KN1.

If it is decided there is no item that is permissible to be disclosed (No in #203), the process is finished.

If it is decided it is permissible to disclose all or a part of the items (Yes in #203), the doctor DR2 asks the patient KN1 for permission to view the medical record information 71. If the permission is obtained, it is entered in the diagnostic type terminal device 3 (Yes in #204). On this occasion, it is possible to ask the patient KN1 to enter a password that only the patient KN1 knows. In this case, the password is recorded in the patient card KR of the patient KN1 in advance, and matching between the entered password and the recorded password is performed. If the permission is not obtained (No in #204), the process is finished.

The medical record information obtaining portion 32 accesses the medical record information server 4 so as to obtain the medical record information 71 indicated by the medical record ID that is read out in the step #202 as well as the medical history file FL1, . . . , the prescription file FL5 from the URL indicated by the medical record information 71 (#205). However, it is allowed to obtain only the information of the item that is decided to be permissible to be disclosed in step #203.

The medical record information output portion 33 delivers the obtained medical record information 71 and contents of the file (#206). For example, the medical record reference screen HG4 as shown in FIG. 14 is displayed on the display device of the diagnostic type terminal device 3 for output. Alternatively, these contents may be printed on a sheet of paper for the output.

The card reader and writer 3RW records history information indicating that the doctor DR2 viewed the medical record information 71 during this consulting in the patient card KR of the patient KN1 (#207). Thus, the doctor in the hospital A can see who viewed the medical record information 71 when the patient KN1 visits the hospital A later.

According to this embodiment, medical record information is disclosed only to a person who satisfies a predetermined condition required by a patient and a doctor. In addition, satisfying the condition is certified by an authentication basis or a public authentication basis that is administrated by a government or an organization such as a medical association. Therefore, medical record information of a patient can be disclosed more appropriately than the conventional system, so that security can be improved.

In this embodiment, an example is described in which the medical record information 71 of the patient KN1 in the hospital A is disclosed to the doctor DR2 in another hospital B. In addition, it is possible to disclose the medical record information 71 in the hospital B to the doctor DR1 in the hospital A when the patient KN1 who took consulting in the hospital B takes consulting again in the hospital A. As a method for realizing this, there are following two methods considered, for example.

In one method, the policy information 72 is set also in the medical record information 71 that is managed in the hospital B similarly to the case of the hospital A. Namely, it is set in advance so that both of the hospitals A and B can view the medical record information 71 of each other.

In another method, at the timing when the doctor DR2 in the hospital B views the medical record information 71 of the patient KN1 in the hospital A, the policy information 72 is set so that the doctor DR1 in the hospital A can view the medical record information 71 of the patient KN1 made by the doctor DR2.

In this embodiment, the medical record information 71 is managed integrally by the medical record information server 4, and the diagnostic type terminal devices 2 and 3 obtain the medical record information 71 from the medical record information server 4 and deliver the same. However, it is possible to record the medical record information 71 in the patient card KR of each patient. In this case, the diagnostic type terminal devices 2 and 3 are structured so that the medical record information 71 can be obtained only if it is decided that the doctor who wants to view the medical record information 71 is qualified.

It is possible to decide whether it is permissible or not to disclose in accordance with the authority information 73 of the doctor DR1 not only in the case where a doctor in another hospital views the medical record information 71 stored in the medical record master 41 in the hospital A but also in the case where the doctor DR1 in the hospital A views the same (step #103 in FIG. 8). In addition, before the doctor DR1 writes the policy information 72 into the patient card KR (#111), it is possible to decide whether the doctor DR1 is authorized to do so in accordance with the authority information 73. It is possible that the authority system 5 performs the decision whether it is permissible or not to disclose the medical record information 71 and whether the doctor DR1 is authorized to write.

In this embodiment, the diagnostic type terminal device 2 that is used by the party whose medical record information 71 is viewed is distinguished from the diagnostic type terminal device 3 that is used by the party who views the information. However, it is possible that one terminal device has both functions of the diagnostic type terminal devices 2 and 3.

In order to improve reliability of the authority information 73, PKI (Public Key Infrastructure) may be adopted. In this case, the authority information 73 is encrypted by a secret key and is recorded on the qualified person card CR of a doctor. The public key certificate of the authority information 73 is also recorded on the qualified person card CR. The diagnostic type terminal device 3 requests the certificate authority to verify the public key certificate to be authentic and performs a process for disclosing the medical record information 71 in accordance with the authority information 73 if the result that the public key certificate is authentic. Note that the request for the verification to the certificate authority is not necessarily performed every time when viewing the medical record information 71, but it is sufficient to perform it at a predetermined interval (once a month for example).

Contents of the policy information 72 and the authority information 73 can be determined freely in accordance with an environment to which the medical record information disclosure system 1 is adopted. For example, it is possible to set the policy information 72 that indicates which authority system 5 issued the authority information 73 to be used for deciding permissibility of disclosure. Namely, the following contents may be set in the policy information 72. The contents is that in the case where “a surgeon in California” is to be permitted to view the information, being or not “a doctor in California” must be decided in accordance with the authority information 73 issued by the authority system 5 of “the medical association in California”, and being or not “a surgeon” must be decided in accordance with the authority information 73 issued by a “** academy”.

In addition, the policy information 72 is set in such way that it is permissible to disclose the medical record information 71 to “a doctor in California”, and the authority information 73 is set in such way that the doctor is “a doctor in Los Angeles”. In this case, their keywords do not match, so the diagnostic type terminal device 3 may decide it is not permissible to disclose the medical record information 71 even if the disclosure condition is satisfied substantially. In this case, it is possible to inquire the authority system 5 that issued the authority information 73 whether or not the doctor is “a doctor in California” for confirmation.

In this embodiment, a case is described above where the medical record information 71 of a patient is disclosed to a doctor in another medical institution. However, the present invention can be applied to other case where other personal information is disclosed. For example, it can be applied to a case where personal information of a citizen living in a region is disclosed to a staff of a local office in another region.

Furthermore, a structure of a whole or a part of the medical record information disclosure system 1, the diagnostic type terminal device 2, the diagnostic type terminal device 3, the medical record information server 4 or the authority system 5, contents of a process, an order of the process or others can be modified if necessary in accordance with the spirit of the present invention.

According to the present invention, personal information such as medical record information can be disclosed only to peoples who are considered to have necessity of the information. Therefore, the present invention can be used effectively in an industry that deals with this personal information.

While the presently preferred embodiments of the present invention have been shown and described, it will be understood that the present invention is not limited thereto, and that various changes and modifications may be made by those skilled in the art without departing from the scope of the invention as set forth in the appended claims.

1. A system for disclosing personal information, comprising:
a storage portion for storing personal information of people who are provided with a service;
a disclosure attribution setting portion for setting a disclosure attribution for each of the personal information, the disclosure attribution being an attribution of people who can see contents of the personal information;
a provider attribution setting portion for setting a provider attribution for each of service providers, the provider attribution being an attribution about a service provider;
a disclosure permissibility decision portion for deciding whether it is permissible or not to disclose the personal information to the provider by comparing the provider attribution of the provider with the disclosure attribution of the personal information; and
an output portion for delivering the personal information to the provider when the disclosure permissibility decision portion decides it is permissible to disclose the personal information to the provider.

2. A system for disclosing personal information, comprising:
a personal information obtaining portion for obtaining personal information from a storage portion for storing the personal information of people who are provided with a service;
a disclosure attribution obtaining portion for obtaining a disclosure attribution of personal information that a service provider wants, the disclosure attribution being an attribution of people who can see contents of the personal information;
a provider attribution obtaining portion for obtaining a provider attribution that is an attribution about the provider; and
a disclosure permissibility decision portion for deciding whether it is permissible or not to disclose the personal information to the provider by comparing the obtained provider attribution of the provider with the disclosure attribution of the personal information, wherein
the personal information obtaining portion obtains the personal information from the storage portion when the disclosure permissibility decision portion decides it is permissible to disclose the personal information to the provider.

3. A system for disclosing medical record information, comprising:
a medical record information storage portion for storing medical record information of patients,
a disclosure target attribution setting portion for setting a disclosure attribution for each of the medical record information, the disclosure attribution being an attribution of people who can see contents of the medical record information;
a medical expert attribution setting portion for setting a medical expert attribution for each of medical experts, the medical expert attribution being an attribution about a medical expert;
a disclosure permissibility decision portion for deciding whether it is permissible or not to disclose contents of the medical record information to the medical expert by comparing the medical expert attribution of the medical expert with the disclosure attribution of the medical record information; and
an output portion for delivering the medical record information to the medical expert when the disclosure permissibility decision portion decides it is permissible to disclose contents of the medical record information to the medical expert.

4. A system for disclosing medical record information, comprising:
a medical record information storage portion for storing medical record information of patients;
a plurality of disclosure target attribution setting portions for setting disclosure attributions respectively for a plurality of medical record information, each of the disclosure attributions being an attribution of people who can see contents of the medical record information;
a medical expert attribution setting portion for setting a medical expert attribution for each of medical experts, the medical expert attribution being an attribution about a medical expert;
a disclosure permissibility decision portion for deciding whether it is permissible or not to disclose contents of the medical record information to the medical expert by comparing one or more of the medical expert attributions of the medical expert with the disclosure attribution of the medical record information; and
an output portion for delivering the medical record information to the medical expert when the disclosure permissibility decision portion decides it is permissible to disclose contents of the medical record information to the medical expert.

5. The system for disclosing medical record information according to claim 4, wherein at least one of the plurality of disclosure target attribution setting portions set the medical expert attribution indicating that the medical expert is qualified for medical practice, and another or other plural disclosure target attribution setting portions set the medical expert attribution indicating specialization of the medical expert.

6. The system for disclosing medical record information according to claim 4, wherein
the disclosure target attribution setting portion sets the disclosure attribution for each item included in the medical record information,
the disclosure permissibility decision portion decides whether it is permissible or not to disclose the contents for each item, and
the output portion delivers only items having contents that are decided to be permissible to be disclosed among the medical record information by the disclosure permissibility decision portion.

7. The system for disclosing medical record information according to claim 4, wherein
the disclosure target attribution setting portion sets a plurality of the disclosure attributions for one medical record information, and
the disclosure permissibility decision portion decides whether it is permissible or not to disclose contents of the medical record information to the medical expert by comparing one or more of the medical expert attributions of the medical expert with the plurality of disclosure attributions of the medical record information.

8. A system for disclosing medical record information, comprising:
a medical record information obtaining portion for obtaining the medical record information from a medical record information storage portion for storing the medical record information of patients;
a disclosure attribution obtaining portion for obtaining a disclosure attribution that is an attribution of people who can see contents of the medical record information that medical experts want to see;
a medical expert attribution obtaining portion for obtaining a medical expert attribution that is an attribution about the medical expert from a medical expert information storage portion; and
a disclosure permissibility decision portion for deciding whether it is permissible or not to disclose contents of the medical record information to the medical expert by comparing the obtained medical expert attribution of the medical expert with the disclosure attribution of the medical record information, wherein
the medical record information obtaining portion obtains the medical record information from the medical record information storage portion when the decision result is obtained that indicates it is permissible to disclose contents of the medical record information to the medical expert.

9. The system for disclosing medical record information according to claim 8, wherein
the medical expert attribution is encrypted by a secret key of a public key cipher system, and
the disclosure permissibility decision portion decides whether it is permissible or not to disclose contents of the medical record information to the medical expert when receiving a notice that indicates a public key certificate of the medical expert attribution of the medical expert is authentic from a certificate authority that issued the public key certificate.

10. The system for disclosing medical record information according to claim 8, wherein
the medical expert information storage portion is a removable storage medium that stores a plurality of medical expert attributions,
the medical expert attribution obtaining portion obtains all of the medical expert attributions stored in the medical expert information storage portion, and
the disclosure permissibility decision portion decides whether it is permissible or not to disclose contents of the medical record information to the medical expert by comparing all of the obtained medical expert attributions with the disclosure attribution of the medical record information.

11. The system for disclosing medical record information according to claim 10, wherein the storage medium is an IC card.

12. A terminal device that is used for the system for disclosing medical record information according to claim 8, the terminal device comprising:
a disclosure attribution setting portion for setting the disclosure attribution for each of the medical record information; and
a medical record information registration portion for registering the medical record information in the medical record information storage portion.

13. The terminal device according to claim 12, further comprising
a disclosure attribution recording portion for making a removable storage medium store the set disclosure attribution.

14. The terminal device according to claim 13, wherein the storage medium is an IC card.

15. A method for disclosing personal information, comprising the steps of:
storing previously personal information of people who are provided with a service;
setting previously a disclosure attribution for each of the personal information, the disclosure attribution being an attribution of people who can see contents of the personal information;
setting previously a provider attribution for each of service providers, the provider attribution being an attribution about a service provider; and
delivering the personal information by a terminal device that performs the processes of
obtaining the provider attribution of the provider who wants the personal information and the disclosure attribution of the personal information,
deciding whether it is permissible or not to disclose the personal information in accordance with the obtained provider attribution and the obtained disclosure attribution,
obtaining the personal information from the storage portion when it is decided that it is permissible to disclose the personal information, and
delivering the obtained personal information.

16. A computer program product for use in a computer that is used for disclosing personal information, the computer program product comprising:
means for accessing a storage portion for storing personal information of people who are provided with a service;
means for obtaining a disclosure attribution that is an attribution of people whose personal information is permissible to be disclosed to a service provider who wants the disclosure;
means for obtaining a provider attribution that is an attribution about the provider;
means for deciding whether it is permissible or not to disclose the personal information to the provider by comparing the obtained provider attribution of the provider with the disclosure attribution of the personal information; and
means for obtaining the personal information from the storage portion when it is decided that it is permissible to disclose the personal information to the provider.
